(19) United States
(12) Patent Application Publication
(10) Pub. No.: US 2021/0332785 A1
(43) Pub. Date: Oct. 28, 2021

(54) Gravity and Hydrologic Power Generation

(71) Applicant: LOVE LIGHT DESIGN LAB, INC., Las Vegas, NV (US)

(72) Inventor: Chris Coleman, Las Vegas, NV (US)

(21) Appl. No.: 17/302,207

(22) Filed: Apr. 27, 2021

Related U.S. Application Data
(60) Provisional application No. 63/016,291, filed on Apr. 28, 2020.

(51) Int. Cl. F03B 7/00; F03B 13/00; F03B 17/06

(52) U.S. Cl. CPC F03B 7/006; F03B 17/06; F03B 13/00

(57) ABSTRACT

A system includes a lower trough, an upper trough, and a float tube in fluid communication with the lower trough. The system includes a track extending from a first location proximate the second end of the float tube to a second location proximate the first end of the float tube and a trolley configured to travel along the track from the first location to the second location, selectively engage a canister when the trolley is in the first location, carry the canister along the track from the first location to the second location, and selectively disengage the canister to deposit the canister into the lower trough, wherein movement of the trolley along the track exerts a force on an electrical generator to cause the electrical generator to generate electrical energy.

### CROSS-REFERENCE TO RELATED APPLICATIONS

This application claims priority to U.S. Provisional Patent Application No. 63/016,291 filed on Apr. 28, 2020 and entitled “Gravity and Hydrologic Power Generation.”

### TECHNICAL FIELD

This application relates to power generation and more particularly to a system configured to use hydrologic and gravitational forces for power generation.

### BACKGROUND

Energy production is one of the great costs of modern society. Many methods of producing energy create side products that are harmful to people and the environment. The burning of fossil fuels releases compounds into the environment. Existing forms of energy production that are “green” also have limitations and harmful side-effects. In conventional applications, hydropower systems are typically located on or in close proximity to a river, lake, reservoir, or other body of water, which can greatly limit geographical locations in which such systems may be located. In many cases, given their need to be near a natural body of water or river, such conventional hydropower systems are situated in locations that can lead to damage to native animal species, particularly fish species that travel upriver to spawn, resulting in further harmful side-effects of such energy generation systems.

### SUMMARY

In a first aspect, the disclosure provides a system for providing power. The system includes: a structure; multiple lift tubes filled with a fluid; multiple canisters; an upper trough; a lower trough; a cable; multiple wheels around which the cable runs; multiple attachment hooks attached to the cable for attaching to the canisters; and at least one dynamo for generating power. The canisters float to the top of the lift tubes. At the top of the lift tubes the canisters enter the upper trough. The canisters float through the upper trough until an attachment hook attaches to a canister. Once a canister is attached to the cable, the cable winds around a wheel at the top of the structure and the cable runs to a wheel at the bottom of the structure. At the bottom of the structure the attachment hooks release the canisters from the cable. The canisters float around the lower trough to the lift tubes. The weight of the canisters causes the cable to be pulled around the wheels and the wheels to turn. The at least one dynamo is attached to one of the wheels, and as the wheel turns the at least one dynamo generates power.

In a second aspect the disclosure provides an apparatus for providing power. The apparatus includes: a structure; multiple lift tubes filled with a fluid; multiple canisters; an upper trough; a lower trough; a cable; multiple wheels around which the cable runs; multiple attachment hooks attached to the cable for attaching to the canisters; and at least one dynamo for generating power. The canisters float to the top of the lift tubes. At the top of the lift tubes the canisters enter the upper trough. The canisters float through the upper trough until an attachment hook attaches to a canister; wherein once a canister is attached to the cable, the cable winds around a wheel at the top of the structure and the cable runs to a wheel at the bottom of the structure. At the bottom of the structure the attachment hooks release the canisters from the cable. The canisters float around the lower trough to the lift tubes. The weight of the canisters causes the cable to be pulled around the wheels and the wheels to turn. The at least one dynamo is attached to one of the wheels, and as the wheel turns the at least one dynamo generates power.

Further aspects and embodiments are provided in the foregoing drawings, detailed description, and claims.

### BRIEF DESCRIPTION OF THE DRAWINGS

The drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIGS. 1A-1D are illustrations of the present power generation system in which FIG. 1A shows a front view of the system, FIGS. 1B and 1C show perspective views of the system, and FIG. 1D shows an interior view of the system.

FIG. 2A depicts a float tube of the present invention, where the float tube is configured to be filled with a fluid and the float tube is configured to receive a canister.

FIG. 2B depicts a canister that may be floated within an interior volume of the float tube of FIG. 2A.

FIGS. 2C-2D depict a canister being loaded into a float tube and floated therein.

FIG. 3A is a perspective view of a bottom trough of the present energy generation system in which a number of canister may be gathered and introduced into one of several float tubes.

FIG. 3B is a perspective view of a top trough of the present energy generation system in which a number of canisters may be gather and introduced into a pickup area for pickup by a trolley.

FIGS. 4A-4C depict a trolley of the present energy generation system.

### DETAILED DESCRIPTION

The following description recites various aspects and embodiments of the invention disclosed herein. No particular embodiment is intended to define the scope of the invention. Rather, the examples provided herein illustrating specific embodiments of the invention provide non-limiting examples of various configurations and methods that are included within the scope of the claimed invention. It is understood that other embodiments may be utilized and changes may be made without departing from the scope of the present invention. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly indicates otherwise. For example, reference to “a substituent” encompasses a single substituent as well as two or more substituents, and the like.

As used herein, “for example,” “for instance.” “such as,” or “including” are meant to introduce examples that further clarify more general subject matter. Unless otherwise expressly indicated, such examples are provided only to aid in understanding embodiments illustrated in the present disclosure and are not meant to be limiting in any fashion. Nor do these phrases indicate any kind of preference for the disclosed embodiment.

As used herein “canister” is meant to refer to containers. These containers are typically buoyant so they rise to the top of a fluid (e.g., water) in which the canister is placed.

As used herein “buoyant force” is meant to refer to one of the forces exerted on an object that is wholly or partially immersed in a fluid. The magnitude of the buoyant force on an object is equal to the weight of the fluid the object disperses. The buoyant force is affected by the density of the fluid, the volume of fluid displaced and the local acceleration due to gravity. Buoyant force is not affected by the mass or density of the object being immersed.

As used herein “buoyancy” is meant to refer to the buoyant force overcoming the weight of the immersed object. Such object may be referred to as being buoyant.

As used herein “lift tube” is meant to refer to hollow tubes at least partially filled with a fluid.

As used herein “electric generator” is meant to refer to a device for converting motive energy or other input mechanical forces into electrical power. Electrical generators may be dynamos, which generate direct current, and/or alternators, which generate alternating current. One method of generating electrical energy involves using a mechanical force to drive or turn a gear, wheel or transmission connected to an electric generator.

The present invention is directed to a system for generating electrical energy. The system relies upon the buoyant force to continuously float weights (also referred to herein as canisters) up through a collection of float tubes. Once the weights float to the top the float tubes, the weights are coupled to a cable and slide down a track back to the bottom of the float tubes. As the weights slide down the track, the weights exert force on the cable, causing the cable to move along the track. The cable is, in turn, coupled to an electrical generator to cause the electrical generator to generate electrical energy. Once the weights slide to the bottom of the track, the weights are decoupled from the cable and returned to the bottom of the float tubes. The weights float up through the float tube and the process continues indefinitely.

In this manner, the weights provide a constant mechanical force pulling on the cable to drive the cable and turn the electrical generator. The weights are constantly fed to the top of the float tubes (and the top of the track) by the buoyant force operating on the weights within the float tubes. In an embodiment of the present system, the cable running on the system's track is wound around a wheel and causes the wheel to spin when the weights descend along the track. This will, in turn, cause an electrical generator coupled to the wheel to operate to create energy. Utilizing buoyancy and gravity in this manner enables an electric generator to be operated while avoiding many of the side effects of other methods of producing power.

Dropping a weight from a height releases energy. By attaching the weight to a line or a cable, the potential energy of the weight can be converted into mechanical energy used to spin or drive a wheel, gear or transmission that is coupled to a dynamo or alternator. As such, the weight's potential energy (and, while sliding down the track, the weight's kinetic energy) can be transformed into electrical energy.

Simply lifting a weight to a suitable height for release uses more energy than is produced by the dropping of the weight due to friction and other energy losses. In an ideal situation the energy used to lift the weight to the height would be equal to the energy released upon dropping the weight. However, even this ideal situation would not result in the net production of energy because the amount of energy produced by the releasing of the weight would be consumed by lifting the weight back to the height for release. As such, another force must be utilized that enables the weight to get to the height of release without consuming all of the energy produced upon release of the weight. In the present system, the buoyant force is used to lift the weight without requiring the input of more energy from the system. Such use of the buoyant force requires that a liquid be contained in such a way as to be high enough to get the weight to the height it needs to be. In the present system, the weight can be large enough to spin the wheel coupled to the electrical generator yet buoyant enough to float to the top of the fluid filled space (e.g., the float tubes).

In general, the present system includes a structure to which tubes and wheels are affixed. The tubes are filled with a fluid and have the same or similar height as the structure. Canisters, which act as weights, are provided. The canisters fit within the tubes and are floated to the top of the structure through the tubes by the buoyant force. At the top of the tubes the canisters are attached to a cable which lifts the canisters and carries them across the structure. The cable winds around a wheel and then down the face of the structure (e.g., along a track). At the base of the structure, the canisters are released from the cable and floated back into the tubes to repeat the process. The canisters are then again floated to the top of the tubes and the process continues. The cable winds around two wheels, one at the top of the structure and one at the bottom of the structure. The weight of the canisters pulls the cable which causes the wheels to turn. Attached to at least one of the wheels is an electric generator.

The present system is scalable to produce any amount of power desired. The canisters, cable length, structure height, interval between canister pick-up and other factors can all be changed based on the amount of power to be output from the system.

Discussion of the individual parts of the system as used in specific embodiments will help understand the system.

The canisters can be sealed hollow containers. In a preferred embodiment the canisters can be made of steel. In a specific embodiment the canisters are made from stainless steel.

In the present system, the lift or float tubes provide the mechanism by which the canisters are lifted to the top of the structure. The lift tubes are filled with water. The canisters enter into the lift tubes through a door that opens outward to allow the canister entry to the inside of the tube. The doors have magnetic attachments and locks. Each of the lift tubes may have a robotic grasping arm which grasps the canister and pulls it into the lift tube. The robotic arm pulls the canister into position in the lift tube. The robotic arm may be positioned on a track that rolls out of and into the lift tube. Once the canister is pulled into the lift tube a door or hatch that divides the entry of the lift tube from the main body of the lift tube is opened and floods the lift tube with water. The entry and the main body of the lift tube are divided by a door that seals magnetically.

When the canister reaches the top of the lift tube it enters a trough and moves out into the trough. The trough is filled with fluid. At the top of the structure are two wheels around which a cable is run. The cable may have hook structures attached to it that engage the top of the canisters. The cable passes over the trough and the cable dips down so that the hook structure can engage with the canister. The cable then lifts the canister out of the trough. The canister stays attached to the cable as the cable runs around the other wheel at the top of the structure. After the cable carries the canister around the wheel the cable travels down the structure. The cable may pass down the structure at a diagonal. The weight of the canister pulls the cable along. The cable winds around a wheel at the bottom of the structure. The wheel at the bottom of the structure turns an electric generator which provides power.

Once at the bottom of the structure, the hook structure releases the canister from the cable where the canister is moved into another lift tube to be taken back to the top of the structure.

The hook structure may have two sides. The front of the hook structure can be configured to open to allow grasping of the canister. When the canister reaches the bottom of the structure the back of the hook structure opens to release the canister.

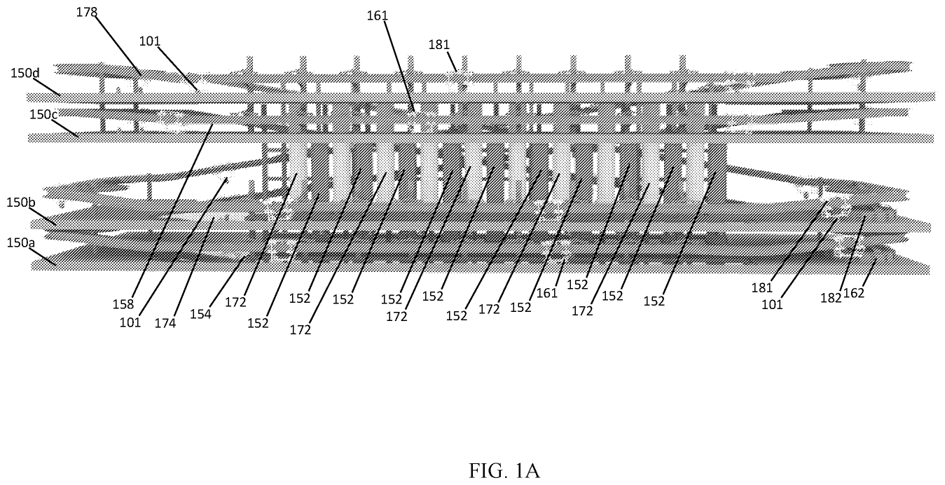

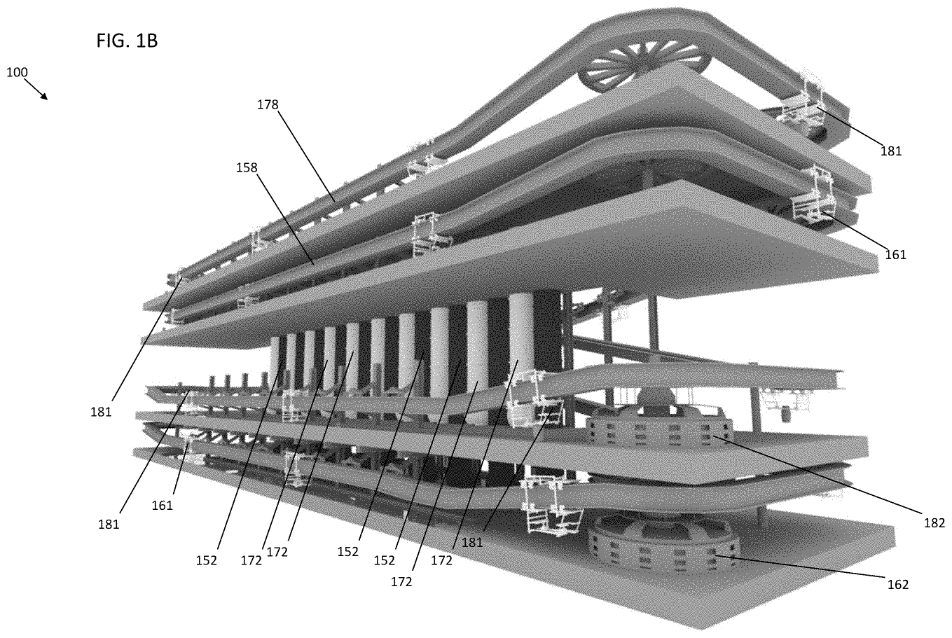

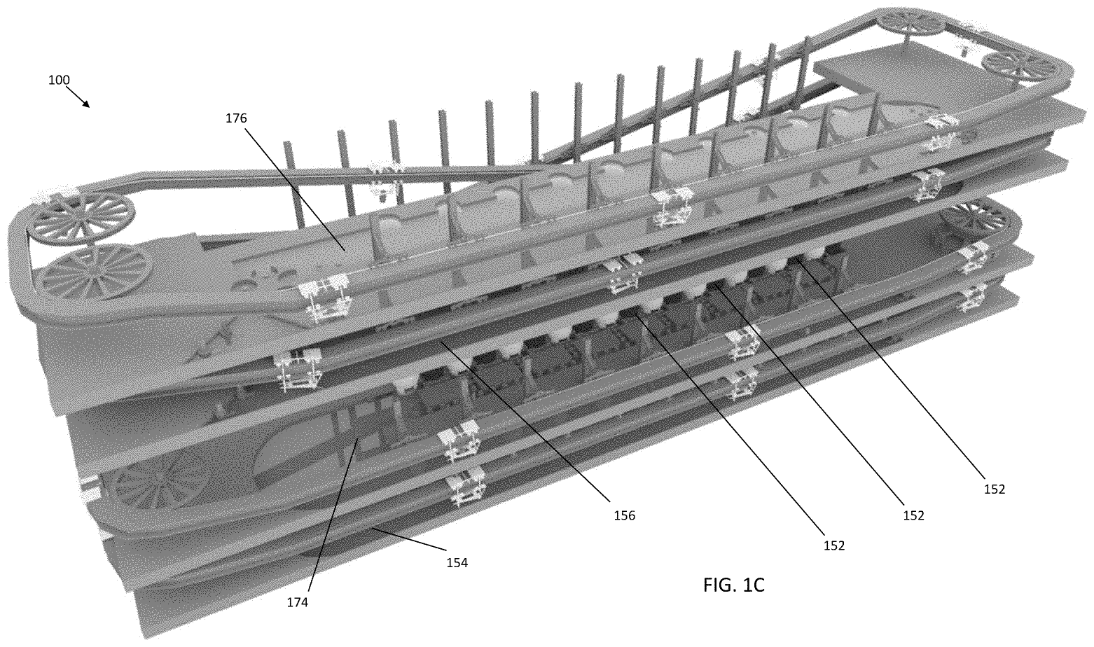

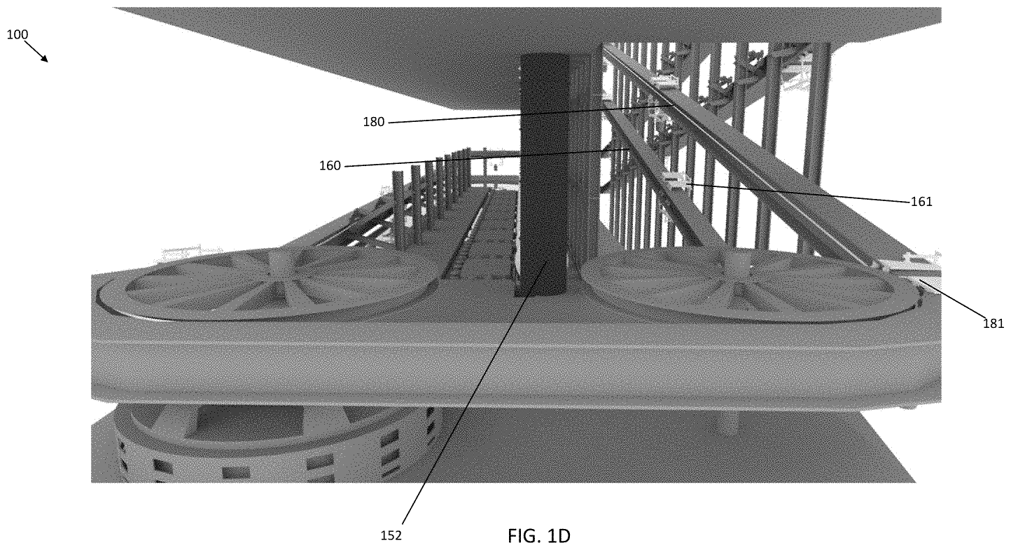

FIGS. 1A-1D are illustrations of the present system 100. FIG. 1A shows a front view of system 100, FIGS. 1B and 1C show perspective views of system 100. FIG. 1D shows an interior view of system 100.

System 100 includes a structure having four floors 150a-d. The size and geometry of system 100 may be selected to satisfy operation needs. In some embodiments, system 100 may have an overall height of about 400 feet, a width of about 300 feet and a depth of about 85 feet, though other implementations may have lesser or greater dimensions. Two independent energy generation systems are integrated into system 100. The first system includes a number of float tubes 152. Float tubes 152 (and float tubes 174, below) may have lengths or heights of about 300 feet or 400 feet and diameters of about 14 feet, depending on the application, though embodiments of system 100 may call for float tubes 152 having greater or lesser heights. Float tubes 152 extend from a lower trough 154 located at floor 150a to an upper trough 156 located at floor 150c (see FIG. 1C). Track 158 runs along structure from a location proximate upper trough 156 to a location proximate lower trough 154 and cable 160 runs along track 158. As described herein, the first energy generation system operates by floating canisters 101 up through float tubes 152 into upper trough 156. The canisters 101 are then positioned within upper trough 156 at a loading location underneath or proximate to cable 160. Trolleys 161, which are coupled to cable 160, pass by and engage with or couple to the canisters 101. The trolley 161, now coupled to a canister 101, descends along track 158, thereby pulling cable 160 along track 158. Cable 160 is coupled to generator 162 so that the movement of cable 160 causes generator 162 to turn thereby generating electrical energy.

At the bottom of structure 100, trolleys 161 release canisters 101 into lower trough 154. Canisters 101 floats through the lower trough 154 to one of lift tubes 152. The canisters 101 are then introduced into one of float tubes 152. The canisters 101 are lifted up through the float tubes 152 and released into upper trough 156. The canister then floats through the upper trough 156 to a loading area. At that time a trolley 161 which is attached to cable 160 passes over the top of the canister 101 grasps the top of the canister 101. As the canisters 101 are grasped by trolley 161, the trolleys 161 travel along track 158, pulling cable 160. Cable 160 is coupled to generator 162 so that the weight of the canisters 101 on cable 160 causes the cable 160 to move thereby operating generator 162 to create electrical energy.

Gravity pulls the canisters 101 from the top of the structure to the bottom of the structure. In a preferred embodiment track 158 runs across the structure at an angle between 20 degrees and 90 degrees. In a more preferred embodiment the angle of track 158 is between 30 and 75 degrees. In a still more preferred embodiment the angle of track 158 is between 40 and 60 degrees.

The second energy generation system of system 100 includes a number of float tubes 172 that extend from a lower trough 174 located at floor 150b to an upper trough 176 located at floor 150d (see FIG. 1C). Track 178 runs along structure from a location proximate upper trough 176 to a location proximate lower trough 174 and cable 180 runs along track 178. As described herein, the first energy generation system operates by floating canisters 101 up through float tubes 172 into upper trough 176. The canisters 101 are then positioned within upper trough 176 at a loading location underneath or proximate to cable 180. Trolleys 181, which are coupled to cable 180, pass by and engage with or couple to the canisters 101. The trolley 181, now coupled to a canister 101, descends along track 178, thereby pulling cable 180 along track 178. Cable 180 is coupled to generator 182 so that the movement of cable 180 causes generator 182 to turn thereby generating electrical energy.

At the bottom of structure 100, trolleys 181 release canisters 101 into lower trough 174. Canisters 101 floats through the lower trough 174 to one of lift tubes 172. The canisters 101 are then introduced into one of float tubes 172. The canisters 101 are lifted up through the float tubes 172 and released into upper trough 176. The canisters 101 then float through the upper trough 176 to a loading area. At that time, a trolley 181 which is attached to cable 180 passes over the top of the canister 101 and grasps the top of the canister 101. As the canisters 101 are grasped by trolley 181, the trolleys 181 travel along track 178, pulling cable 180. Cable 180 is coupled to generator 182 so that when the weight of the canisters 101 on cable 180 causes the cable 180 to move along track 178 to move, which in turn operates generator 182 to create electrical energy. When operating system 100 a central control room may determine the operation and timing of trolleys 181 to ensure pickup and drop-off occur at the correct times and locations. Or, in some cases, the system may be automated and mechanically operated so that the operation of trolleys 181 is determined by mechanical gear linkages and the like.

Gravity pulls the canisters 101 from the top of the structure to the bottom of the structure. In a preferred embodiment track 178 runs across the structure at an angle between 20 degrees and 90 degrees. In a more preferred embodiment the angle of track 178 is between 30 and 75 degrees. In a still more preferred embodiment the angle of track 178 is between 40 and 60 degrees.

In some embodiments, system 100 includes backup power to move cable 160 or 180 in emergency situations, such as where there may be a timing problem with the picking up of the canisters at the top of the structure. Timing issues within system 100 may be managed by controlling pump operation and water flow within the upper and lower troughs and timing of gate operations for controlling the pickup of canisters in the upper trough. If the timing gets “off” and the canisters are not picked up regularly the cable may slow and can even stop because there is no force pulling the cable around the wheels. The back-up power may be a battery back-up where the batteries are charged by the system and energy is stored for emergencies. In alternative embodiments another type of emergency power such as diesel or gas generators, solar power, or other power sources can be used.

The system can be deployed with any number of lift tubes. One embodiment utilizes ten lift tubes to float the canisters from the bottom of the structure to the top of the structure. More tubes generally equates to more power produced. In some alternative embodiments multiple electric generators are used to produce more power. Additional electric generators are associated with the wheels around which the cable runs along track 158. The number of electric generators able to be utilized in the system is directly proportional to the number of wheels used in the system and attached to the structure.

It should be understood that although FIGS. 1A-1D depict system 100 as including two independent power generation systems, implementations of the system may include only a single power generation system with a single set of float tubes, single upper and lower troughs, and a single track and cable system running between the system's upper and lower troughs. Conversely, it should also be understood that other structures may be built or implemented that may incorporate three or more independent power generation systems configured in accordance with the power generation systems of the present claim.

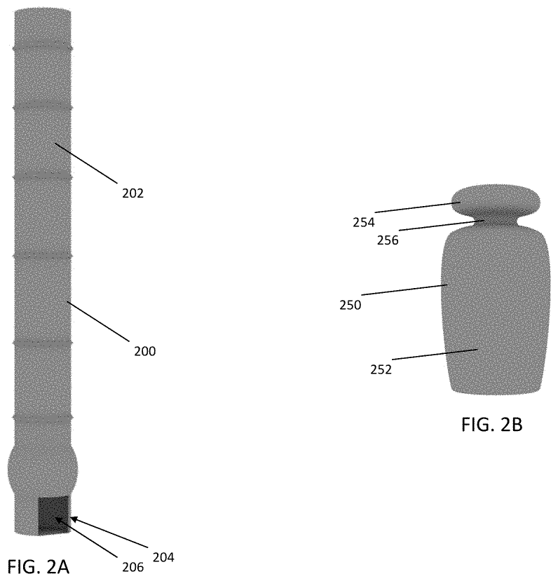

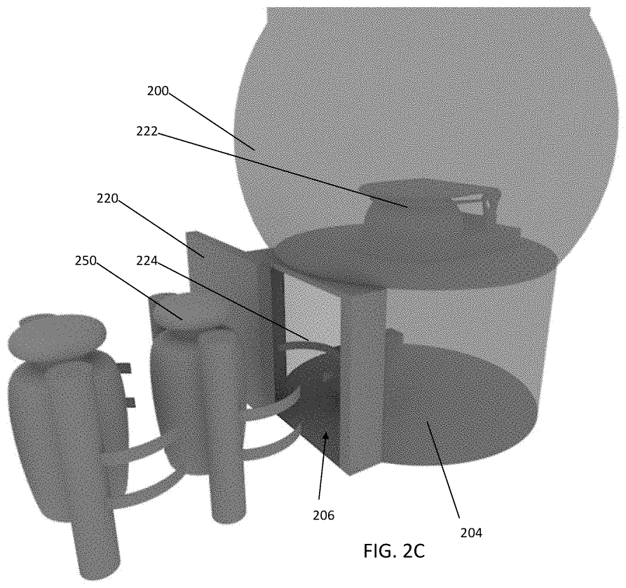

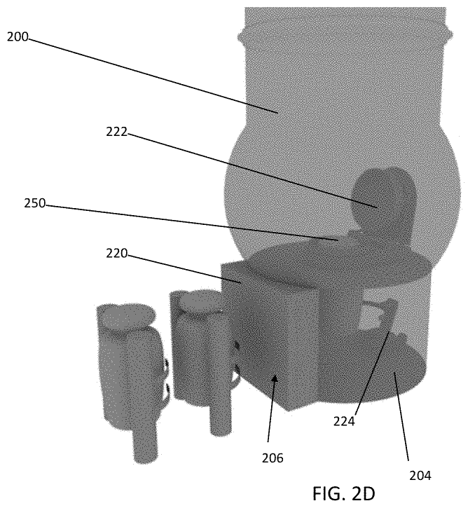

FIGS. 2A-2D depicts aspects of the float tube and canisters of the present power generation system. FIG. 2A depicts a float tube 200 (e.g., float tubes 152, 172 of FIGS. 1A-1D). FIG. 2B depicts canister 250 (e.g., canisters 101 of FIGS. 1A-1D). FIGS. 2C-2D depict canister 250 being loaded into float tube 200 and floated therein.

As shown in FIG. 2A, float tube 200 includes float shaft 202 and float tube entry area 204. During typical operation, entry area 204 of float tube 200 would be submerged under water (or other fluid) in the lower trough, while the float shaft 202 of float tube 200 would extend upwards out of the water. During operation, canisters 250 (FIG. 2B) are introduced into an internal volume of float tube entry area 204 through opening 206. Once positioned within float tube 200, canisters 250 can be floated upwards through float shaft 202. An example canister 250 is shown in FIG. 2B. Canister 250 includes a canister body 252 that is connected to a canister head 204 by a relatively narrow neck 206 portion.

In an embodiment, canister 250 may be approximately 16 feet tall, with a diameter of 8 feet, though the height of canister 250 may range from 10 feet to 16 feet, though other dimensions may be used. In this embodiment canister 250 weighs approximately 44,000 lbs, though, depending on the application canister 250 may have any suitable weight. In an embodiment, canister 250 weight ranges from 40,000 lbs to 80,000 lbs. In some cases, the canister 250 is made of steel, such as stainless steel. The canisters 250 can be hollow. The hollow construction of the canisters 250 can provide that they are buoyant. Buoyancy is important to the functioning of the system because the canisters float to the top of the lift tubes. The canister size and the size of the system can be scaled up or down, other embodiments of the system will utilize smaller canisters, and thus a smaller system.

FIGS. 2C and 2D depict further detail of float tube 200 and illustrate how canister 250 is introduced into float tube 200 and floated therein. When canister 250 reaches lift tube 200 the door 220 (also referred to herein as a gate or hatch) opens to allow canister 250 to enter float tube entry area 204 of float tube 200. A piston (not shown) or other actuator moves door 220 to allow access to the lift tube entry area 204. Canister 250 enters the lift tube entry area 204 of lift tube 200 and is held in entry area 204. Entry area 204 is divided from the rest of the lift tube 200 by horizontal gate 222 (also referred to herein as a valve or hatch). It can be important to have a division of the entry area 204 from the rest of the lift tube 20. The canisters 250 move up the lift tube 200 by being buoyant. If the lift tube did not have a separate entry area 204, every time the gate 220 was opened water in the lift tube 200 would flood out of the lift tube 200 through opening 206. To keep the water within the lift tube 200 the entry area 204 is separated from the rest of the lift tube 200 by the horizontal gate 222. Furthermore, because the lift tube entry area 204 of lift tube 200 is submerged (e.g., within lower trough 254, when canister 250 is introduced into entry area 204, gate 220 can be closed to seal in the canister 250 and water into entry area 204. When horizontal gate 222 is opened (see FIG. 2D), a minimal amount of water flows downward from float tube shaft 202 into entry area 204 of float tube 200. This can minimize water losses.

In an embodiment, access gate 220 or door may be lifted and lowered by a winch and cable. Gate 220 may be sealed to opening 206 of entry area 204 using magnets. Specifically, gate 220 may incorporate a number of magnets that are configured to correspond to a similarly-arranged number off magnets in the periphery of opening 206. In that case, the magnets may be physically moved in either gate 220 or opening 206 so that the magnetic force connecting the magnets is broken and the access gate 220 is moved to allow another canister to enter the lift tube. Alternatively, gate 220 may be sealed to opening 206 using a number of mechanical locks (e.g., camlocks, magnetic interlocks, physical beams or similar structures).

Horizontal gate (or hatch) 222 may be sealed using similar mechanisms as utilized to seal access gate 220, though in embodiments, horizontal gate 222 may be implemented differently than access gate 220. In an embodiment, horizontal gate 222 may be implemented in the manner of a marine water-tight hatch, such as those found in vessels such as submarines or military ships.

In some embodiment, a robotic arm 224 is configured to reach out from the entry area 204 to couple to a canister 250 and pull the canister 250 into the entry area 204. The arm 224 may be attached to a piston that causes the arm 224 to reach out. The end of arm 224 may incorporate a magnet that attaches to a canister and enables the arm 224 to pull the canister 250 into the entry area 204. The canister 250 enters the lift tube 200 entry area 204 and may be held in place by a second magnet incorporated into the bottom of the entry area 204.

In still further embodiments, arm 224 is mounted to a track at the bottom of the entry area 204 of the tube 220 enabling the arm 224 to move outside entry area 204 in order to grab or manipulate a canister 250. The grabbing arm 224 can pull the canisters fully into the entry area so the entry area can be flooded with water and the canisters can float to the top of the lift tube 200. In some embodiments the grabbing portion of the grabbing arm 224 is magnetic and attaches to the side of each canister 250. In other embodiments the grabbing portion of the grabbing arm 224 is a claw that articulates and grasps the canister 250 to pull it into float tube 200.

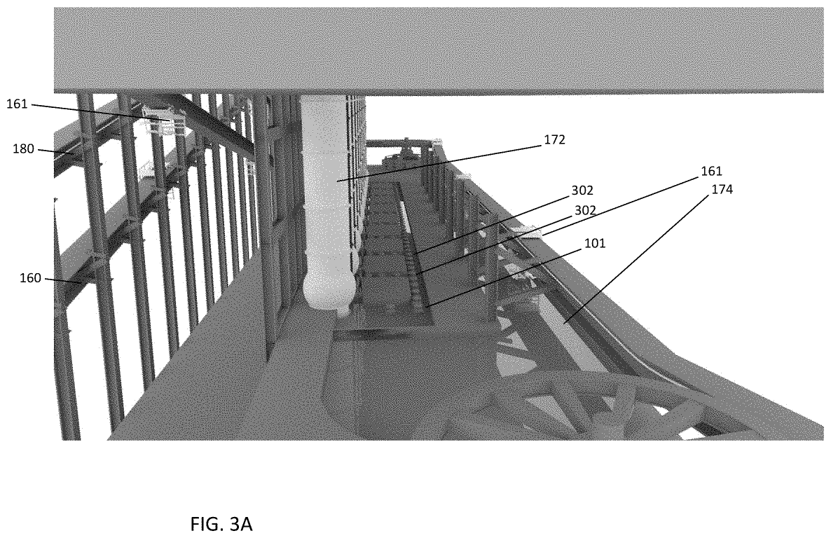

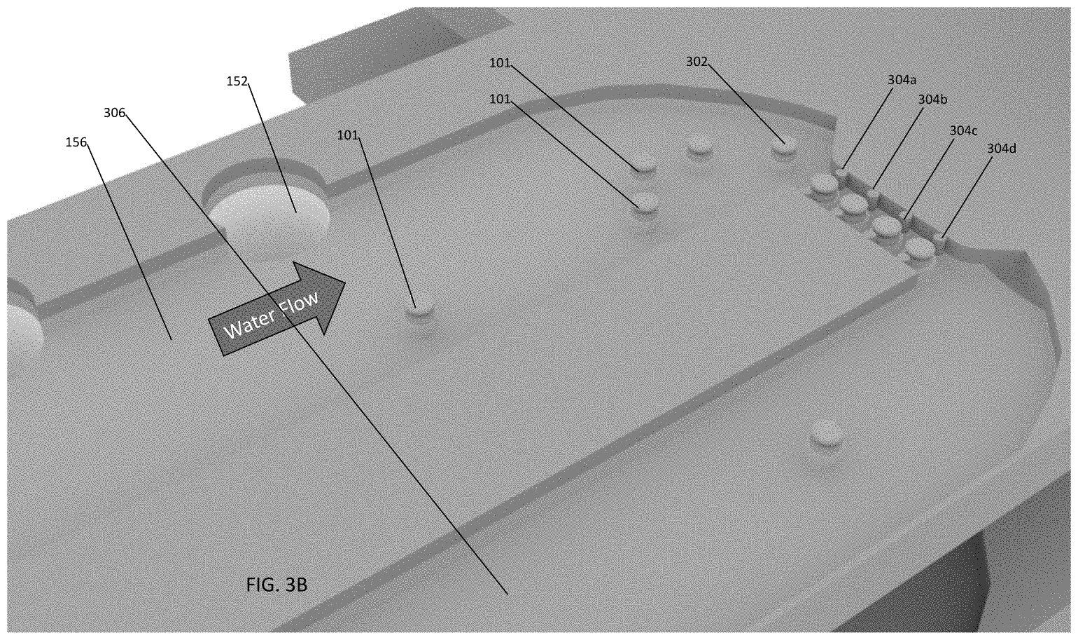

FIG. 3A depicts a view of lower trough 174 of the system 100 (lower trough 154 is configured in a similar manner as lower trough 174). Lower trough 174 is filled with water which floats canisters 101. The water in the lower trough 174 has a current that directs the canisters toward the lift tubes 172. The canisters 101. The current in lower trough 174 may be imparted by pumps. As the canisters 101 float through the lower trough 174 the canisters 101 are directed toward the lift tubes 172 by directional gates 302. In some embodiments the directional gates are fixed in place, in these embodiments the directional gates are passive. The water flows through the trough and pushes the canisters into the directional gates which direct the canisters to the lift tubes. In other embodiments the directional gates open and close, these active or articulating directional gates help direct the canisters into the lift tubes.

In certain embodiments the directional gates are solid, that is water will not pass through the gate. In some embodiments the directional gates are solid with holes in the base of the directional gate. In other embodiments the directional gates are screen-like. The screen-like gates allow the water to pass through the gate. The embodiments with solid directional gates are preferably embodiments utilizing passive gates. The embodiments where the directional gates are passive and solid direct the water toward the lift tubes. The current running through the lower trough pushes the canisters along the trough. When the directional gates are solid, the gates further direct water in the direction of the lift tubes. This further directs the canisters into the lift tubes. In embodiments utilizing active or articulated directional lift gates it is preferable that the directional gates be screen-like. When the directional gates are active or articulated, the directional gate moves through the water. Being screen-like helps the directional gate move through the water. The screen-like gate has less resistance to the water, this makes moving the gate through the water more effective. Additionally, the decreased resistance places less stress on the articulated gate. Articulated gates with screen-like gates require less power to move through the water. In embodiments that have solid articulated gates the gates need to be more robustly constructed to deal with the stress imparted by moving through the water. The increased robustness and increased resistance from moving the water and moving through the water increases the power requirements for the articulated gates. This increased power requirement necessitates a larger motor. The larger motor is more expensive as well as requiring more power. This can lead to higher costs overall.

In embodiments with articulated gates, the gates direct the canisters into the lift tubes by pushing them into the lift tubes. In some embodiments the articulated directional gates close automatically when the gate detects a canister pushing against the gate. In these embodiments the articulated directional gates have pressure sensors that after being pressed, start the motor attached to the articulated gate to close the gate. The pressure sensors are another reason why the screen-like construction of the articulated gate is preferred. The screen-like construction offers less interference with the pressure sensor than a solid construction gate. The solid construction gate has the pressure of the current in the water through the lower trough pushing on the gate. The pressure sensor would have to be calibrated to ignore the pressure of the water current. If the pressure sensor is not calibrated the gate will attempt to close continuously.

The directional gates assist in getting the canisters into the lift tubes. Once the canisters are in the lift tubes the process of lifting the canisters to the top of the structure as described above continues.

FIG. 3B depicts a view of upper trough 156 of the system 100 (upper trough 176 is configured in the same manner as upper trough 156). Canisters 101 (e.g., canister 250) float to the top of lift tube 152. Once at the top of lift tube 152, canisters 101 enter the upper trough 156. Once released into upper trough 156, canisters 101 are pushed by a current flow in the water of the upper trough 156. As the current carries the floating canisters 101 around the upper trough 156, the canisters 101 reach control gates 304a-304d. Control gates 304a-304d regulate when the canisters 101 are allowed into the canister pick up area 306 of upper trough 156. Because there may be multiple lift tubes 152 floating canisters to the top of the structure, this means that there are multiple canisters entering the upper trough 156. The system is powered by canisters attaching to the cable and utilizing their weight to pull the cable and turn the wheels. If the canisters are too closely grouped, they will interfere with the ability of the canisters to attach to the cable. The control gates 304a-304d regulate when the canisters are allowed into the pick-up area 306.

Control gate 304a is the first gate 304 the canisters 101 encounter. When control gate 304a opens it allows canisters 101 into the staging area. Once in the staging area control gate 304d regulates the interval between canisters 101 allowed into the pick-up area 306. Canisters 101 are regularly picked up from the pick-up area 306 (e.g., by trolleys 161 coupled to cable 160) at specific intervals. It can be important that the canisters 101 enter the pick-up area 306 at the interval the trolleys are passing through the pick-up area 306. The control gates 304a-304d assist in ensuring that the canisters 101 are ready to be picked-up by the trolleys as they pass through the pick-up area 306. As the system's power comes from the weight of the canisters 101 pulling the cable along, it can be important that the cable constantly have canister attached to the cable. If the cable does not pick-up canisters, the system could stall and have to rely at least temporarily on stored power to get the system back on-line.

The upper trough contains a return portion that allows canisters which have missed being picked up to return to the control gates and eventually to the pick-up area.

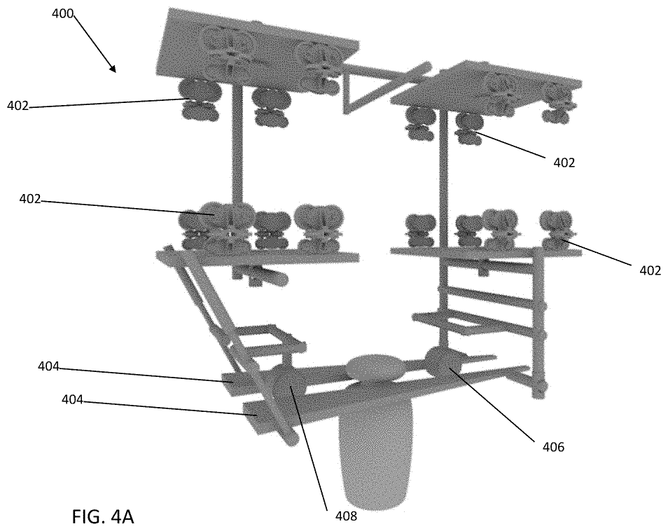

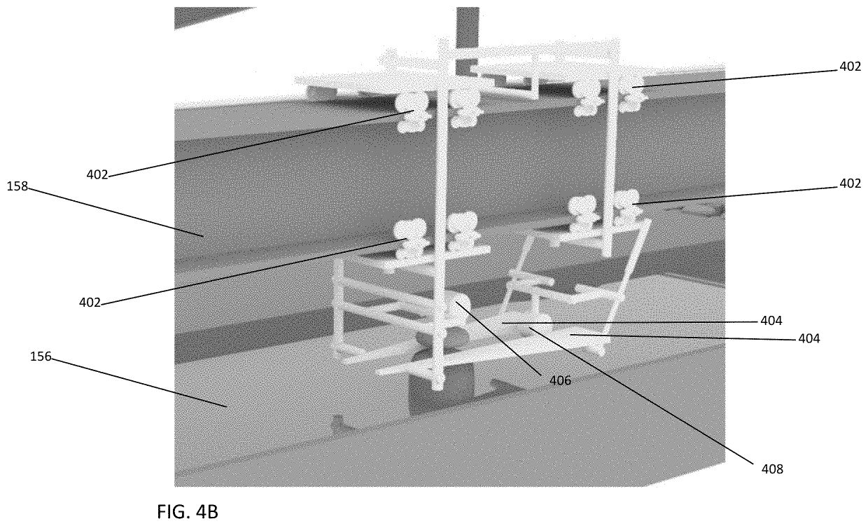

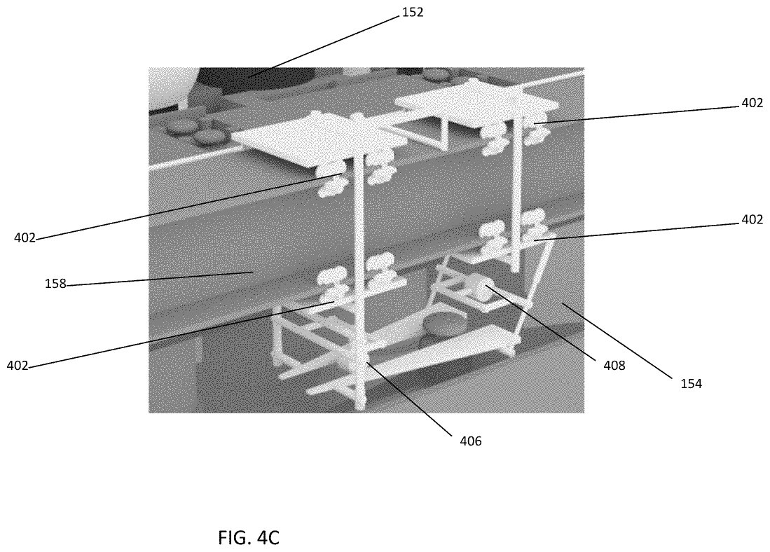

FIGS. 4A-4C depict aspects of trolley 400 (e.g., trolley 161 of FIGS. 1A-1D). Trolley 400 includes a number of wheel engagement members 402 that are configured to engage with a track (e.g., track 158 of FIGS. 1A-1D) to secure trolley 400 to the track and enable trolley to slide along the track. Trolley 400 includes an attachment hook 404 on the pick and drop trolley 400. The attachment hook 404 is used to engage with a neck of the canisters (e.g., neck 256 of canister 250, FIG. 2B) to pick up the canisters from an upper trough (e.g., upper trough 156 FIG. 1C) and drop off the canister at a lower trough (e.g., lower trough 154, FIG. 1A). The attachment hook 404 is designed so the attachment portion (e.g., the neck 256) of the canister enters the front (i.e., the portion of trolley 400 at the right-hand side of FIG. 4A) of the attachment hook 404 and is released from the back of the attachment hook 404 (e.g., the portion of trolley 400 at the left-hand side of FIG. 4A). The attachment hook 404 is open at the front to capture the attachment portion of the canister. As the lift and drop trolley 400 on the cable passes over the canister, the attachment hook 404 “grabs” the attachment portion of the canister. When picking up a canister, a drop-down gate 406 located at the front of attachment hook 404 is lifted enabling the canister to enter the attachment hook 404 (this configuration is shown in FIG. 4B). Once the attachment hook 404 has “grabbed” the canister, drop-down gate 406 closes off the front opening of the attachment hook 404 (the configuration of attachment hook 404 shown in FIG. 4A). When dropping a canister (e.g., into lower trough 154), a rear drop-down gate 408 opens, enabling the canister to exit from a rear portion of attachment hook 404. This drop-off configuration is shown in FIG. 4C.

The trolley 400 and attachment hook 404 thereof may be configured with safety locks configured to engage when a canister 101 has been coupled to the trolley 400. Such a safety lock may prevent one or more of gates 406 or 408 from rotating open which a canister 100 is being carried.

In one specific embodiment of the present energy generation system (e.g., system 100 of FIGS. 1A-1D), the canisters may each weigh approximately 60,000 pounds. The canisters are picked up via the trolleys or carriers at the top trough and are dropped off at the bottom trough. During operation of the system, the trolleys may be configured to travel along the system's track from a first location proximate the first trough to a second location proximate the second trough at a speed of approximately 7 feet per second. In such an implementation, each canister may spend 68.6 seconds on the line assuming the first 20 feet is parasitic as the canister accelerates to line speed. Canisters may be spaced 25 feet apart and the down-slope portion of the track and cable is about 500 feet long. In that case, with 25 foot spacing and 500 feet of track/cable length there are 25 canisters on the track and cable at all times. Consequently, in that configuration, there are approximately 1,500,000 pounds of continuous downforce. Each canister has approximately 23,030,880 potential ft-lbs of force. Parasitic losses are calculated at approximately 1,892,630 ft-lbs of force. Potential available remaining energy per container is approximately 21,138,250 ft-lbs. As such, horsepower available is approximately 550 foot pounds per second (21,138,250/68.6 sec)/550=560 Horsepower per container 0.560 horsepower at 25 canisters is 14,000 horsepower continuous output per cableway.

In an embodiment, a system includes a lower trough filled with a fluid, an upper trough filled with the fluid, wherein the upper trough is located above the lower trough, a float tube extending between the lower trough and the upper trough and in fluid communication with the lower trough and the upper trough, the float tube including a shaft and an entry area connected to the shaft, and a hatch configured to selectively inhibit fluid flow between the entry area and the float tube, a track extending from a first location proximate the upper trough to a second location proximate the lower trough, a cable extending along the track, a trolley connected to the cable, the trolley being configured to travel along the track, selectively engage a canister in the upper trough to carry the canister along the track from the first location to the second location, and selectively disengage the canister to deposit the canister into the lower trough, and an electrical generator coupled to the cable.

The system may include a plurality of float tubes, wherein each float tube of the plurality of float tubes is in fluid communication with the upper trough and the lower trough. The entry area of the float tube can include an opening and a door configured to selectively inhibit fluid flow from the entry area of the float tube to the lower trough through the opening, wherein the opening is sized to allow the canister to pass through the door from the lower trough into the entry area of the float tube. The system may include a robotic arm in the entry area of the float tube, the robotic arm being configured to selectively couple to a canister located in the lower trough and pull the canister into the entry area of the float tube through the opening. The trolley may be configured to exert a mechanical force on the cable when the trolley travels along the track. The upper trough may be located directly over the lower trough. The float tube may extend vertically between the lower trough and the upper trough. The canister may be buoyant in the fluid. The upper trough may include a pickup area and at least one gate configured to control a movement of the canister into the pickup area of the upper trough.

In another embodiment, a system includes a lower trough including a fluid, a float tube in fluid communication with the lower trough, the float tube including a first end proximate to the lower trough and a second end distal from the first end, a track extending from a first location proximate the second end of the float tube to a second location proximate the first end of the float tube, and a trolley configured to travel along the track from the first location to the second location, selectively engage a canister when the trolley is in the first location, carry the canister along the track from the first location to the second location, and selectively disengage the canister to deposit the canister into the lower trough, wherein movement of the trolley along the track exerts a force on an electrical generator to cause the electrical generator to generate electrical energy.

The system may include a plurality of float tubes, wherein each float tube of the plurality of float tubes is in fluid communication with the lower trough. The float tube may include an entry area and the entry area may include an opening and a door configured to selectively inhibit fluid flow from the entry area of the float tube to the lower trough through the opening, wherein the opening is sized to allow the canister to pass through the opening from the lower trough into the entry area of the float tube. The system may include a robotic arm in the entry area of the float tube, the robotic arm being configured to selectively couple to a canister located in the lower trough and pull the canister into the entry area of the float tube through the opening.

In another embodiment, a method includes placing a canister in an entry area of a float tube, wherein the float tube extends between a lower trough and an upper trough, includes a shaft connected to the entry area and a hatch configured to selectively inhibit fluid flow between the entry area and the float tube, and a fluid, wherein the canister is buoyant in the fluid, operating the hatch to causing the canister to float through the shaft of the float tube to the upper trough, when the canister is in the upper trough, coupling the canister to a trolley is coupled to a cable, wherein the cable runs along a track from a first location proximate the upper trough to a second location proximate the lower trough, causing the trolley to move along the track from the first location to the second location, wherein movement of the trolley along the track exerts a force on the cable to cause an electric generator coupled to the cable to generate electrical energy, and when the trolley is in the second location, decoupling the trolley from the canister to deposit the canister into the lower trough.

The entry area of the float tube may include an opening and a door configured to selectively inhibit fluid flow from the entry area of the float tube to the lower trough through the opening, wherein the opening is sized to allow the canister to pass through the door from the lower trough into the entry area of the float tube. The method may include causing a robotic arm in the entry area of the float tube to couple to a canister located in the lower trough and pull the canister into the entry area of the float tube through the opening. The upper trough may be located directly over the lower trough. The float tube may extend vertically between the lower trough and the upper trough. The upper trough may include a pickup area and at least one gate and further comprising operating the gate to control a movement of the canister into the pickup area of the upper trough.

All patents and published patent applications referred to herein are incorporated herein by reference. However, any reference to prior publication is not, and should not be taken as an acknowledgement, admission, or suggestion that the prior publication, or any information derived from it is part of the general common knowledge in the field of endeavor to which this specification relates. The invention has been described with reference to various specific and preferred embodiments and techniques. Nevertheless, it is understood that many variations and modifications may be made while remaining within the spirit and scope of the invention.

What is claimed is:

1. A system, comprising:
a lower trough filled with a fluid;
an upper trough filled with the fluid, wherein the upper trough is located above the lower trough;
a float tube extending between the lower trough and the upper trough and in fluid communication with the lower trough and the upper trough, the float tube including a shaft and an entry area connected to the shaft, and a hatch configured to selectively inhibit fluid flow between the entry area and the float tube;
a track extending from a first location proximate the upper trough to a second location proximate the lower trough;
a cable extending along the track;
a trolley connected to the cable, the trolley being configured to travel along the track, selectively engage a canister in the upper trough to carry the canister along the track from the first location to the second location, and selectively disengage the canister to deposit the canister into the lower trough; and
an electrical generator coupled to the cable.

2. The system of claim 1, further comprising a plurality of float tubes, wherein each float tube of the plurality of float tubes is in fluid communication with the upper trough and the lower trough.

3. The system of claim 1, wherein the entry area of the float tube includes an opening and a door configured to selectively inhibit fluid flow from the entry area of the float tube to the lower trough through the opening, wherein the opening is sized to allow the canister to pass through the door from the lower trough into the entry area of the float tube.

4. The system of claim 3, further comprising a robotic arm in the entry area of the float tube, the robotic arm being configured to selectively couple to a canister located in the lower trough and pull the canister into the entry area of the float tube through the opening.

5. The system of claim 1, wherein the trolley is configured to exert a mechanical force on the cable when the trolley travels along the track.

6. The system of claim 1, wherein the upper trough is located directly over the lower trough.

7. The system of claim 6, wherein the float tube extends vertically between the lower trough and the upper trough.

8. The system of claim 1, wherein the canister is buoyant in the fluid.

9. The system of claim 1, wherein the upper trough includes a pickup area and at least one gate configured to control a movement of the canister into the pickup area of the upper trough.

10. A system, comprising:
a lower trough including a fluid;
a float tube in fluid communication with the lower trough, the float tube including a first end proximate to the lower trough and a second end distal from the first end;
a track extending from a first location proximate the second end of the float tube to a second location proximate the first end of the float tube; and
a trolley configured to travel along the track from the first location to the second location, selectively engage a canister when the trolley is in the first location, carry the canister along the track from the first location to the second location, and selectively disengage the canister to deposit the canister into the lower trough, wherein movement of the trolley along the track exerts a force on an electrical generator to cause the electrical generator to generate electrical energy.

11. The system of claim 10, further comprising a plurality of float tubes, wherein each float tube of the plurality of float tubes is in fluid communication with the lower trough.

12. The system of claim 10, wherein the float tube includes an entry area and the entry area includes an opening and a door configured to selectively inhibit fluid flow from the entry area of the float tube to the lower trough through the opening, wherein the opening is sized to allow the canister to pass through the opening from the lower trough into the entry area of the float tube.

13. The system of claim 12, further comprising a robotic arm in the entry area of the float tube, the robotic arm being configured to selectively couple to a canister located in the lower trough and pull the canister into the entry area of the float tube through the opening.

14. The system of claim 10, wherein the canister is buoyant in the fluid.

15. A method, comprising:
placing a canister in an entry area of a float tube, wherein the float tube extends between a lower trough and an upper trough, includes a shaft connected to the entry area and a hatch configured to selectively inhibit fluid flow between the entry area and the float tube, and a fluid, wherein the canister is buoyant in the fluid;
operating the hatch to causing the canister to float through the shaft of the float tube to the upper trough;
when the canister is in the upper trough, coupling the canister to a trolley is coupled to a cable, wherein the cable runs along a track from a first location proximate the upper trough to a second location proximate the lower trough;
causing the trolley to move along the track from the first location to the second location, wherein movement of the trolley along the track exerts a force on the cable to cause an electric generator coupled to the cable to generate electrical energy; and
when the trolley is in the second location, decoupling the trolley from the canister to deposit the canister into the lower trough.

16. The method of claim 15, wherein the entry area of the float tube includes an opening and a door configured to selectively inhibit fluid flow from the entry area of the float tube to the lower trough through the opening, wherein the opening is sized to allow the canister to pass through the door from the lower trough into the entry area of the float tube.

17. The method of claim 16, further comprising causing a robotic arm in the entry area of the float tube to couple to a canister located in the lower trough and pull the canister into the entry area of the float tube through the opening.

18. The method of claim 15, wherein the upper trough is located directly over the lower trough.

19. The method of claim 18, wherein the float tube extends vertically between the lower trough and the upper trough.

20. The method of claim 15, wherein the upper trough includes a pickup area and at least one gate and further comprising operating the gate to control a movement of the canister into the pickup area of the upper trough.
